(19) United States
(12) Patent Application Publication
(10) Pub. No.: US 2025/0326235 A1
(43) Pub. Date: Oct. 23, 2025

(54) LIQUID EJECTION APPARATUS AND METHOD OF CONTROLLING LIQUID EJECTION APPARATUS

(71) Applicant: SEIKO EPSON CORPORATION, Tokyo (JP)

(72) Inventors: Shintaro KOMURO, MATSUMOTO-SHI (JP); Kazuyoshi OHASHI, MATSUMOTO-SHI (JP); Kohei UENO, SHIOJIRI-SHI (JP)

(21) Appl. No.: 19/184,063

(22) Filed: Apr. 21, 2025

(30) Foreign Application Priority Data
Apr. 23, 2024 (JP) 2024-069936

(51) Int. Cl. B41J 11/00; B41J 2/17; B41J 2/175; B41J 3/60

(52) U.S. Cl. CPC B41J 11/0015; B41J 2/1707; B41J 2/175; B41J 3/60

(57) ABSTRACT

A liquid ejection apparatus includes a first liquid ejector configured to eject a pretreatment liquid as a liquid for pretreatment onto a medium, a second liquid ejector configured to eject a recording liquid as a liquid for recording onto the medium onto which the liquid is ejected by the first liquid ejector, and a controller configured to control the first liquid ejector and the second liquid ejector, wherein one surface of the medium is defined as a first surface and another surface of the medium is defined as a second surface, the controller is configured to perform an adjustment of the ejection of the pretreatment liquid to suppress a difference in liquid absorption between the first surface and the second surface based on recording data.

The present application is based on, and claims priority from JP Application Serial Number 2024-069936, filed Apr. 23, 2024, the disclosure of which is hereby incorporated by reference herein in its entirety.

### BACKGROUND

### 1. Technical Field

The present disclosure relates to a liquid ejection apparatus that ejects a liquid onto a medium. Further, the present disclosure relates to a method of controlling a liquid ejection apparatus.

### 2. Related Art

An inkjet recording apparatus described in JP-A-2019-188699 includes a liquid supply unit that supplies a liquid to a sheet conveyed thereto. The liquid supplied by the liquid supply unit includes color ink and a pretreatment liquid which is supplied to the sheet before the color ink is supplied.

Therefore, the liquid supply unit includes a head unit that ejects the color ink and a head unit that ejects the pretreatment liquid. The pretreatment liquid is assumed to be white ink. The head unit that ejects the pretreatment liquid is disposed adjacent to the head unit that ejects the color ink upstream in a sheet conveyance direction.

JP-A-2019-188699 is an example of the related art.

When the pretreatment liquid is ejected onto the sheet in addition to the color ink, an amount of liquid absorption by the sheet increases to make a curl of the sheet conspicuous in some cases compared to when the color ink is ejected alone onto the sheet.

### SUMMARY

A liquid ejection apparatus according to the present disclosure for solving the problems described above includes a first liquid ejector configured to eject a pretreatment liquid as a liquid for pretreatment onto a medium, a second liquid ejector configured to eject a recording liquid as a liquid for recording onto the medium onto which the liquid is ejected by the first liquid ejector, and a controller configured to control the first liquid ejector and the second liquid ejector, wherein one surface of the medium is defined as a first surface and another surface of the medium is defined as a second surface, the controller is configured to perform an adjustment of the ejection of the pretreatment liquid to suppress a difference in liquid absorption between the first surface and the second surface based on recording data.

Further, a liquid ejection apparatus according to the present disclosure includes a first liquid ejector configured to eject a pretreatment liquid as a liquid for pretreatment onto a medium, a second liquid ejector configured to eject a recording liquid as a liquid for recording onto the medium onto which the liquid is ejected by the first liquid ejector, and a controller configured to control the first liquid ejector and the second liquid ejector, wherein one surface of the medium is defined as a first surface and another surface of the medium is defined as a second surface, the controller is configured to eject the pretreatment liquid in a region of the first surface corresponding to an ejection region of the recording liquid onto the second surface, and eject the pretreatment liquid in a region of the second surface corresponding to an ejection region of the recording liquid onto the first surface.

Further, a method of controlling a liquid ejection apparatus according to the present disclosure is a method of controlling a liquid ejection apparatus including a first liquid ejector configured to eject a pretreatment liquid as a liquid for pretreatment onto a medium, and a second liquid ejector configured to eject a recording liquid as a liquid for recording onto the medium onto which the liquid is ejected by the first liquid ejector, wherein one surface of the medium is defined as a first surface and another surface of the medium is defined as a second surface, the method including, performing an adjustment of the ejection of the pretreatment liquid to suppress a difference in liquid absorption between the first surface and the second surface based on recording data.

Further, a method of controlling a liquid ejection apparatus according to the present disclosure is a method of controlling a liquid ejection apparatus including a first liquid ejector configured to eject a pretreatment liquid as a liquid for pretreatment onto a medium, and a second liquid ejector configured to eject a recording liquid as a liquid for recording onto the medium onto which the liquid is ejected by the first liquid ejector, wherein one surface of the medium is defined as a first surface and another surface of the medium is defined as a second surface, the method including, ejecting the pretreatment liquid in a region of the first surface corresponding to an ejection region of the recording liquid onto the second surface, and ejecting the pretreatment liquid in a region of the second surface corresponding to an ejection region of the recording liquid onto the first surface.

### BRIEF DESCRIPTION OF THE DRAWINGS

FIG. 1 is a diagram illustrating a medium conveyance path of a liquid ejection unit.

FIG. 2 is a block diagram illustrating a control system of the liquid ejection unit.

FIG. 3 is a diagram schematically showing a flow path of a liquid.

FIG. 4 is a diagram illustrating a medium conveyance path of a liquid ejection apparatus.

FIG. 5 shows an example of a pretreatment liquid ejection region and an ink ejection region.

FIG. 6 is a diagram illustrating a medium conveyance path of a liquid ejection apparatus.

FIG. 7 is a diagram illustrating a medium conveyance path of the liquid ejection apparatus.

FIG. 8 is a diagram showing an example of pretreatment liquid ejection regions and ink ejection regions on first and second surfaces of the medium.

FIG. 9 is a flowchart showing a flow of processing when recording is performed on both sides of the medium.

FIG. 10 is a flowchart showing a flow of a determination on an adjustment of ejection of the pretreatment liquid.

FIG. 11 is a diagram showing an example of the pretreatment liquid ejection region and the ink ejection region of the first surface and the second surface of the medium.

FIG. 12 is a diagram showing a relationship between a fiber grain direction of the medium and amounts of vertical and horizontal margins.

FIG. 13 is a diagram showing the relationship between the fiber grain direction of the medium and the amounts of the vertical and horizontal margins.

### DESCRIPTION OF EMBODIMENTS

The present disclosure is schematically explained below.

A liquid ejection apparatus according to a first aspect includes a first liquid ejector configured to eject a pretreatment liquid as a liquid for pretreatment onto a medium, a second liquid ejector configured to eject a recording liquid as a liquid for recording onto the medium onto which the liquid is ejected by the first liquid ejector, and a controller configured to control the first liquid ejector and the second liquid ejector, wherein one surface of the medium is defined as a first surface and another surface of the medium is defined as a second surface, the controller is configured to perform an adjustment of the ejection of the pretreatment liquid to suppress a difference in liquid absorption between the first surface and the second surface based on recording data.

According to the present aspect, since the controller performs the adjustment of the ejection of the pretreatment liquid to suppress the difference in liquid absorption between the first surface and the second surface based on the recording data, it is possible to suppress the curl caused by the difference in liquid absorption.

Here, the “liquid absorption” in the “difference in liquid absorption between the first surface and the second surface based on the recording data” means liquid absorption of the first surface or the second surface when assuming that the pretreatment liquid and the recording liquid are ejected based on the recording data. Further, the “difference in liquid absorption” in the “difference in liquid absorption between the first surface and the second surface based on the recording data” includes either one or both of a difference in liquid absorption amount between the first surface and the second surface, and a difference in liquid absorption range between the first surface and the second surface.

A second aspect is an aspect according to the first aspect, wherein the controller is configured to perform an adjustment of the ejection of the pretreatment liquid based on information of the medium.

When the medium is hard to curl, such as when the medium is thick or high in rigidity, the adjustment of the ejection of the pretreatment liquid may be unnecessary or just a minor adjustment of the ejection may be sufficient in some cases.

According to the present aspect, since the controller performs the adjustment of the ejection of the pretreatment liquid based on the information of the medium, it is possible to appropriately suppress the curl of the medium while suppressing the ejection amount of the pretreatment liquid.

A third aspect is an aspect according to one of the first and second aspects, wherein the difference in liquid absorption is a difference between an ejection amount of the recording liquid onto the first surface and an ejection amount of the recording liquid onto the second surface.

When the pretreatment liquid is ejected to a region where the recording liquid is to be ejected, it is possible to determine the difference in liquid absorption based on the ejection amount of the recording liquid. According to the present aspect, since the difference in liquid absorption is the difference between the ejection amount of the recording liquid onto the first surface and the ejection amount of the recording liquid onto the second surface, the difference in liquid absorption can be easily determined.

A fourth aspect is an aspect according to the first aspect, wherein the difference in liquid absorption is a difference between a sum of ejection amounts of the pretreatment liquid and the recording liquid onto the first surface and a sum of ejection amounts of the pretreatment liquid and the recording liquid onto the second surface.

According to the present aspect, since the difference in liquid absorption is the difference between the sum of the ejection amounts of the pretreatment liquid and the recording liquid onto the first surface and the sum of the ejection amounts of the pretreatment liquid and the recording liquid onto the second surface, the difference in liquid absorption can be more accurately figured out, and thus the difference in liquid absorption can be more appropriately suppressed.

Note that the present aspect may be dependent from not only the first aspect but also the second aspect. Further, the present aspect may be dependent from the third aspect by selectively using the third aspect and the present aspect.

A fifth aspect is an aspect according to the fourth aspect, wherein the controller is configured to perform an adjustment of the ejection of the pretreatment liquid such that a sum of ejection amounts of the pretreatment liquid and the recording liquid onto the first surface is equal to a sum of ejection amounts of the pretreatment liquid and the recording liquid onto the second surface.

According to the present aspect, since the controller performs the adjustment of the ejection of the pretreatment liquid such that the sum of the ejection amounts of the pretreatment liquid and the recording liquid onto the first surface is equal to the sum of the ejection amounts of the pretreatment liquid and the recording liquid onto the second surface, the difference in liquid absorption can be made zero. Therefore, the difference in liquid absorption can be more appropriately suppressed, and by extension, the curl caused by the difference in liquid absorption can be more appropriately suppressed.

A sixth aspect is an aspect according to one of the fourth and fifth aspects, wherein the controller is configured to eject the pretreatment liquid to a region of the first surface corresponding to an ejection region of the recording liquid onto the second surface, or eject the pretreatment liquid to a region of the second surface corresponding to an ejection region of the recording liquid onto the first surface.

For example, when the amount of liquid absorption is small in the region of the first surface corresponding to the ejection region of the recording liquid onto the second surface, the curl is apt to occur. Similarly, when the amount of liquid absorption is small in the region of the second surface corresponding to the ejection region of the recording liquid onto the first surface, the curl is apt to occur. According to the present aspect, since the controller ejects the pretreatment liquid to the region of the first surface corresponding to the ejection region of the recording liquid onto the second surface or ejects the pretreatment liquid to the region of the second surface corresponding to the ejection region of the recording liquid onto the first surface, it is possible to appropriately suppress the difference in liquid absorption, and by extension, it is possible to more appropriately suppress the curl caused by the difference in liquid absorption.

A seventh aspect is an aspect according to the first aspect, wherein the controller is configured to eject the pretreatment liquid to a second region outside a first region which is an ejection region of the pretreatment liquid corresponding to an ejection region of the recording liquid when increasing an ejection amount of the pretreatment liquid in the adjustment of the ejection of the pretreatment liquid.

According to the present aspect, the difference in liquid absorption can be suppressed by ejecting the pretreatment liquid to the second region. Further, scattering of paper dust can be suppressed by ejecting the pretreatment liquid to the second region.

Note that the first region is not limited to a region completely coinciding with the ejection region of the recording liquid, and may be a region provided with a margin with respect to the ejection region of the recording liquid.

The present aspect may be dependent from not only the first aspect but also any one of the second to sixth aspects.

An eighth aspect is an aspect according to the seventh aspect, wherein an ejection amount of the pretreatment liquid per unit area in the second region is smaller than an ejection amount of the pretreatment liquid per unit area in the first region.

According to the present aspect, since the ejection amount of the pretreatment liquid per unit area in the second region is smaller than the ejection amount of the pretreatment liquid per unit area in the first region, it is possible to suppress the difference in liquid absorption while saving the pretreatment liquid, and by extension, it is possible to suppress the curl caused by the difference in liquid absorption.

A liquid ejection apparatus according to a ninth aspect includes a first liquid ejector configured to eject a pretreatment liquid as a liquid for pretreatment onto a medium, a second liquid ejector configured to eject a recording liquid as a liquid for recording onto the medium onto which the liquid is ejected by the first liquid ejector, and a controller configured to control the first liquid ejector and the second liquid ejector, wherein one surface of the medium is defined as a first surface and another surface of the medium is defined as a second surface, the controller is configured to eject the pretreatment liquid in a region of the first surface corresponding to an ejection region of the recording liquid onto the second surface, and eject the pretreatment liquid in a region of the second surface corresponding to an ejection region of the recording liquid onto the first surface.

According to the present aspect, since the controller ejects the pretreatment liquid to the region of the first surface corresponding to the ejection region of the recording liquid onto the second surface and ejects the pretreatment liquid to the region of the second surface corresponding to the ejection region of the recording liquid onto the first surface, it is possible to appropriately suppress the difference in liquid absorption between the first surface and the second surface, and by extension, it is possible to suppress the curl caused by the difference in liquid absorption.

A tenth aspect is an aspect according to the first aspect, wherein a first liquid ejection unit including the first liquid ejector and a second liquid ejection unit including the second liquid ejector are coupled to each other.

According to the present aspect, in the configuration in which the first liquid ejection unit and the second liquid ejection unit are coupled to each other, the functions and the advantages of the first aspect described above can be obtained.

Note that the present aspect may be dependent from not only the first aspect but also any one of the second to ninth aspects.

An eleventh aspect is an aspect according to the tenth aspect, wherein each of the first liquid ejection unit and the second liquid ejection unit includes an attachment portion to which a liquid container storing the liquid is attached, and a recording liquid container as the liquid container storing the recording liquid and a pretreatment liquid container as the liquid container storing the pretreatment liquid are configured to be alternatively attached to the attachment portion.

According to the present aspect, since the recording liquid container that stores the recording liquid and the pretreatment liquid container that stores the pretreatment liquid can be alternatively attached to the attachment portion, a dedicated liquid ejection unit that ejects the pretreatment liquid becomes unnecessary, the number of usage modes of the two liquid ejection units increases, and the usability for the user is improved.

A twelfth aspect is an aspect according to the eleventh aspect, wherein the first liquid ejection unit includes a first flow path that is a flow path of a liquid from the attachment portion to the first liquid ejector, the second liquid ejection unit includes a second flow path that is a flow path of a liquid from the attachment portion to the second liquid ejector, a first cleaning liquid container storing a cleaning liquid configured to clean the first flow path is configured to be attached to the attachment portion of the first liquid ejection unit, and a second cleaning liquid container storing a cleaning liquid configured to clean the second flow path is configured to be attached to the attachment portion of the second liquid ejection unit.

According to the present aspect, since the first cleaning liquid container storing the cleaning liquid for cleaning the first flow path can be attached to the attachment portion of the first liquid ejection unit, it is possible to easily clean the first flow path. Similarly, since the second cleaning liquid container storing the cleaning liquid for cleaning the second flow path can be attached to the attachment portion of the second liquid ejection unit, it is possible to easily clean the second flow path.

A thirteenth aspect is an aspect according to the twelfth aspect, wherein the first liquid ejection unit and the second liquid ejection unit are same in configuration.

According to the present aspect, since the first liquid ejection unit and the second liquid ejection unit are the same in configuration, usability for the user is improved compared to when the first liquid ejection unit and the second liquid ejection unit have respective configurations different from each other.

Note that the present aspect may be dependent from not only the twelfth aspect but also the tenth aspect or the eleventh aspect described above.

A fourteenth aspect is an aspect according to the tenth aspect, further including a inversion unit configured to invert the medium received from the first liquid ejection unit to convey the medium to the second liquid ejection unit.

When the first liquid ejection unit and the second liquid ejection unit are provided, it is possible to eject the pretreatment liquid onto the first surface with the first liquid ejection unit, and to eject the recording liquid onto the first surface with the second liquid ejection unit. Further, it is possible to eject the pretreatment liquid onto the second surface with the first liquid ejection unit, and to eject the recording liquid onto the second surface with the second liquid ejection unit.

Here, a time period from when the pretreatment liquid is ejected to the first surface with the first liquid ejection unit to when the recording liquid is ejected to the first surface with the second liquid ejection unit is defined as time Tm1.

Further, a time period from when the pretreatment liquid is ejected to the second surface with the first liquid ejection unit to when the recording liquid is ejected to the second surface with the second liquid ejection unit is defined as time Tm2.

According to the present aspect, since the inversion unit that inverts the medium received from the first liquid ejection unit and conveys the medium to the second liquid ejection unit is provided, it is possible to suppress a difference between the time Tm1 and the time Tm2. Accordingly, it is possible to suppress a difference in recording quality between the first surface and the second surface.

Note that the present aspect may be dependent from not only the tenth aspect but also any one of the eleventh to thirteenth aspects.

A method of controlling a liquid ejection apparatus according to a fifteenth aspect is a method of controlling a liquid ejection apparatus including a first liquid ejector configured to eject a pretreatment liquid as a liquid for pretreatment onto a medium, and a second liquid ejector configured to eject a recording liquid as a liquid for recording onto the medium onto which the liquid is ejected by the first liquid ejector wherein one surface of the medium is defined as a first surface and another surface of the medium is defined as a second surface, the method including, performing an adjustment of the ejection of the pretreatment liquid to suppress a difference in liquid absorption between the first surface and the second surface based on recording data.

According to the present aspect, since the adjustment of the ejection of the pretreatment liquid is performed to suppress the difference in liquid absorption between the first surface and the second surface based on the recording data, it is possible to suppress the curl caused by the difference in liquid absorption.

A method of controlling a liquid ejection apparatus according to a sixteenth aspect is a method of controlling a liquid ejection apparatus including a first liquid ejector configured to eject a pretreatment liquid as a liquid for pretreatment onto a medium, and a second liquid ejector configured to eject a recording liquid as a liquid for recording onto the medium onto which the liquid is ejected by the first liquid ejector, wherein one surface of the medium is defined as a first surface and another surface of the medium is defined as a second surface, the method including, ejecting the pretreatment liquid in a region of the first surface corresponding to an ejection region of the recording liquid onto the second surface, and ejecting the pretreatment liquid in a region of the second surface corresponding to an ejection region of the recording liquid onto the first surface.

According to the present aspect, since the pretreatment liquid is ejected to the region of the first surface corresponding to the ejection region of the recording liquid onto the second surface and the pretreatment liquid is ejected to the region of the second surface corresponding to the ejection region of the recording liquid onto the first surface, it is possible to appropriately suppress the difference in liquid absorption between the first surface and the second surface, and by extension, it is possible to suppress the curl caused by the difference in liquid absorption.

The present disclosure will be specifically described below.

An X-Y-Z coordinate system illustrated in each drawing is an orthogonal coordinate system, and the Y-axis direction is a direction crossing the conveyance direction of the medium, that is, a medium width direction, and is an apparatus depth direction. In the present embodiment, out of the side surfaces forming a circumference of an apparatus main body 2 of the liquid ejection unit 1, the side surface at the +Y direction side is a back surface, and the side surface at the −Y direction side is a front surface.

The X-axis direction is an apparatus width direction, and the +X direction is the left side and the −X direction is the right side when viewed from an operator of the liquid ejection unit 1. Further, the −X direction is a direction in which the medium is fed from each medium cassette described later. Further, the +X direction is a conveyance direction of the medium at a position opposed to a liquid ejector 12.

The Z-axis direction is a vertical direction, that is, an apparatus height direction, the +Z direction is an upward direction, and the −Z direction is a downward direction.

Hereinafter, a direction in which the medium is conveyed may be referred to as “downstream,” and the opposite direction may be referred to as “upstream” in some cases. In each drawing, a medium conveyance path is represented by a broken line. In the liquid ejection unit 1, the medium is conveyed through the medium conveyance path represented by the broken line.

In the present embodiment, the liquid ejection unit 1 is an inkjet printer that performs recording by ejecting ink, which is an example of a liquid, onto the medium represented by recording paper. Note that the liquid ejection apparatus described later is an apparatus including a plurality of liquid ejection units 1. However, the liquid ejection apparatus may include a single liquid ejection unit 1, and in this case, the liquid ejection unit 1 may be referred to as the liquid ejection apparatus 1.

Note that in the present specification, the terms “recording” and “printing” may be used in some cases, but both have the same meaning in that an image is formed on a medium by ejecting a liquid onto the medium. Therefore, “recording” may be reworded as “printing” or “image formation,” and “printing” may be reworded as “printing” or “image formation.”

The liquid ejection unit 1 includes a plurality of medium cassettes, specifically, a first medium cassette 3, a second medium cassette 4, a third medium cassette 5, and a fourth medium cassette 6 along the vertical direction in a lower portion of the apparatus main body 2 including the liquid ejector 12 described later. Hereinafter, when these medium cassettes are not distinguished from each other, they are simply referred to as medium cassettes.

Each of the medium cassettes is provided with a pickup roller that feeds the medium housed therein toward the −X direction. Reference numerals 21, 22, 23, and 24 denote pickup rollers provided respectively to the medium cassettes. Note that the configuration for the medium housed therein to come into contact with the pickup roller may be a configuration in which the pickup roller moves forward and backward with respect to the medium, or may be a configuration in which the medium is pushed up by an elevating plate provided to each medium cassette.

In addition, each of the medium cassettes is provided with a feeding roller pair that further feeds downstream the medium fed by the pickup roller. Reference numerals 25, 26, 27, and 28 denote the feeding roller pairs respectively provided to the medium cassettes.

Note that in the following description, it is assumed that the “roller pair” is configured with a drive roller which is driven by a power source such as a motor and a driven roller which is driven to rotate by being in contact with the drive roller unless otherwise described.

Conveyance roller pairs 29, 33 apply feeding forth to the medium fed from the first medium cassette 3 to feed the medium to a conveyance roller pair 34. Conveyance roller pairs 30, 29, and 33 apply feeding forth to the medium fed from the second medium cassette 4 to feed the medium to the conveyance roller pair 34. Conveyance roller pairs 31, 30, 29, and 33 apply feeding forth to the medium fed from the third medium cassette 5 to feed the medium to the conveyance roller pair 34. Conveyance roller pairs 32, 31, 30, 29, and 33 apply feeding forth to the medium fed from the fourth medium cassette 6 to feed the medium to the conveyance roller pair 34. A reference symbol T1 represents a conveyance path of the medium which is fed from each of the medium cassettes and reaches the conveyance roller pair 34.

The medium to which the feeding forth is applied by the conveyance roller pair 34 is fed to a position between the liquid ejector 12 and a conveyance belt 66, that is, to a liquid ejecting position opposed to the liquid ejector 12. The conveyance roller pair 34 constitutes a conveyance unit that conveys the medium to a position between the liquid ejector 12 and the conveyance belt 66.

The liquid ejector 12 ejects the liquid onto a surface of a medium. In the present embodiment, the liquid ejector 12 is a line head in which a plurality of nozzles 13 that eject the liquid is disposed over the entire region in the medium width direction. However, the liquid ejector 12 may be an ink ejection head that is mounted on a carriage and ejects the liquid while moving in the medium width direction.

The liquid ejector 12 according to the present embodiment adopts piezoelectric elements which change in volume when a voltage is applied. Further, by controlling the drive waveform of the piezoelectric element, it is possible to control movement of a meniscus of a nozzle 13 to control a size and ejection speed of a droplet to be ejected.

Note that in the present embodiment, the plurality of nozzles 13 include a nozzle capable of ejecting yellow ink, a nozzle capable of ejecting magenta ink, a nozzle capable of ejecting cyan ink, and a plurality of nozzles capable of ejecting black ink. The ink of each color is an example of the recording liquid for performing recording on the medium. Note that as will be described later in detail, a cleaning liquid can be ejected, and a pretreatment liquid, which is a liquid for pretreatment, can be ejected, from the nozzles that eject the ink of respective colors.

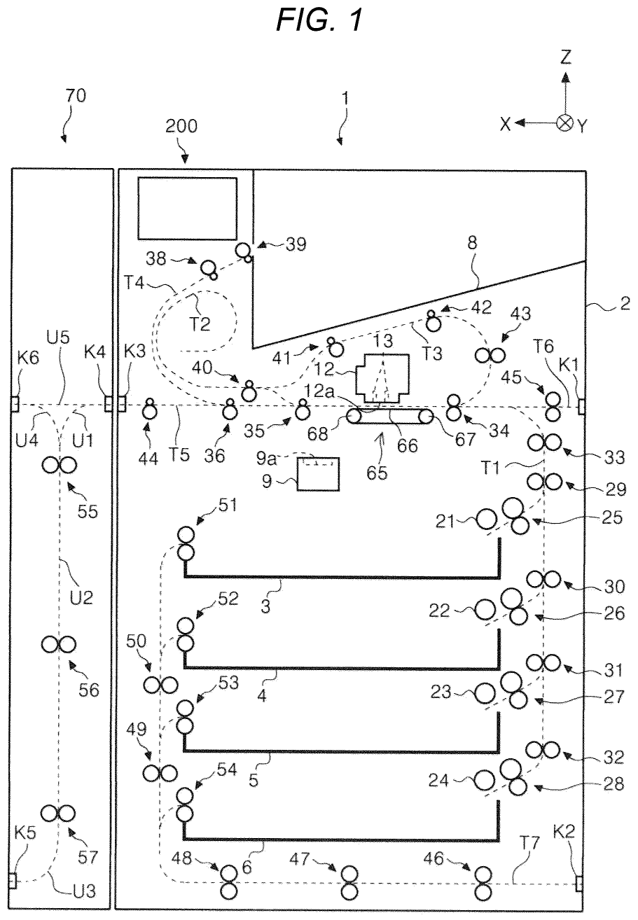

Then, the conveyance belt 66 is an endless belt wound around the drive roller 67 and the driven roller 68, and rotates when the drive roller 67 is driven by a motor (not shown). The medium is conveyed to a position opposed to the liquid ejector 12 while being adsorbed to a belt surface of the conveyance belt 66. The drive roller 67, a driven roller 68, and the conveyance belt 66 constitute a belt unit 65. The belt unit 65 uses the drive roller 67 as a rotation shaft, and is disposed to be rotatable with a power source (not shown), and rotates to thereby switch between a state in which the medium can be conveyed and a position (not shown) retracted from the liquid ejector 12 as illustrated in FIG. 1.

The medium onto which the liquid is ejected by the liquid ejector 12 is fed toward either of a conveyance roller pair 36 and a conveyance roller pair 40 by a conveyance roller pair 35 located downstream of the conveyance belt 66. Therefore, a path switching flap (not shown) is disposed in the vicinity of the downstream of the conveyance roller pair 35.

When it is not performed that the surface of the medium is inverted and the liquid is ejected onto the medium again, the medium is fed from the conveyance roller pair 35 toward the conveyance roller pair 36. A discharge path T4 and a discharge path T5 can be selected downstream of the conveyance roller pair 36. Therefore, a path switching flap (not shown) is disposed in the vicinity of the downstream of the conveyance roller pair 36.

When the discharge path T4 is selected, the medium is discharged to a discharge tray 8 through the discharge path T4. A conveyance roller pair 38 and a conveyance roller pair 39 are disposed in the discharge path T4.

When the discharge path T5 is selected, the medium is discharged toward the +X direction from a discharge portion K3 of the apparatus main body 2 through the discharge path T5. A conveyance roller pair 44 is disposed in the discharge path T5.

When a inversion unit 70 described later is coupled to the liquid ejection unit 1, the medium discharged from the discharge portion K3 enters the inversion unit 70 from the receiving portion K4 of the inversion unit 70.

When the surface of the medium is inverted and the liquid is ejected onto the medium again, the medium is fed from the conveyance roller pair 35 toward the conveyance roller pair 40 to enter a switchback path T2. Subsequently, the rotational direction of the conveyance roller pair 40 is switched, the medium is switched back to enter a inversion path T3, and is fed to the conveyance roller pair 34 by conveyance roller pairs 41, 42, and 43.

The side surface at the −X direction side of the liquid ejection unit 1 is provided with receiving portions K1, K2 that receive the medium. The receiving portion K1 is disposed at a height position corresponding to a position between the liquid ejector 12 and the belt unit 65 in the apparatus height direction. Further, in the present embodiment, height positions of the receiving portion K1 and the discharge portion K3 are substantially the same.

The medium received from the receiving portion K1 is fed to the conveyance roller pair 34 by the conveyance roller pair 45. A reference symbol T6 denotes a conveyance path through which the medium received from the receiving portion K1 is conveyed. The receiving portion K1 may also serve as a feeding port when feeding the medium mounted on a mounting portion (not shown) provided to the side surface at the −X direction side.

The receiving portion K2 is disposed at a position lower than a position of the fourth medium cassette 6 in the apparatus height direction.

The medium received from the receiving portion K2 is conveyed to any one of the first medium cassette 3, the second medium cassette 4, the third medium cassette 5, and the fourth medium cassette 6 through a carry-in path T7. More particularly, conveyance roller pairs 46, 47, and 48 are provided to the carry-in path T7 at a lower side of the fourth medium cassette 6, and apply feeding force to the medium to convey the medium toward the +X direction, and then further convey the medium upward.

A conveyance roller pair 54 is disposed at the +X direction side with respect to the fourth medium cassette 6. A path switching flap (not shown) is disposed upstream of the conveyance roller pair 54, and the medium is conveyed to either the conveyance roller pair 54 or a conveyance roller pair 49. When the medium is conveyed to the conveyance roller pair 54, feeding force toward the −X direction is applied to the medium by the conveyance roller pair 54, and the medium is carried in the fourth medium cassette 6.

A conveyance roller pair 53 is disposed at the +X direction side with respect to the third medium cassette 5. A path switching flap (not shown) is disposed downstream of the conveyance roller pair 49, and the medium is conveyed to either the conveyance roller pair 53 or a conveyance roller pair 50. When the medium is conveyed to the conveyance roller pair 53, feeding force toward the −X direction is applied to the medium by the conveyance roller pair 53, and the medium is carried in the third medium cassette 5.

A conveyance roller pair 52 is disposed at the +X direction side with respect to the second medium cassette 4. A path switching flap (not shown) is disposed downstream of the conveyance roller pair 50, and the medium is conveyed to either the conveyance roller pair 52 or a conveyance roller pair 51. When the medium is conveyed to the conveyance roller pair 52, feeding force toward the −X direction is applied to the medium by the conveyance roller pair 52, and the medium is carried in the second medium cassette 4.

The conveyance roller pair 51 is disposed at the +X direction side with respect to the first medium cassette 3, and when the medium is conveyed to the conveyance roller pair 51, feeding force toward the −X direction is applied to the medium by the conveyance roller pair 51, and the medium is carried in the first medium cassette 3.

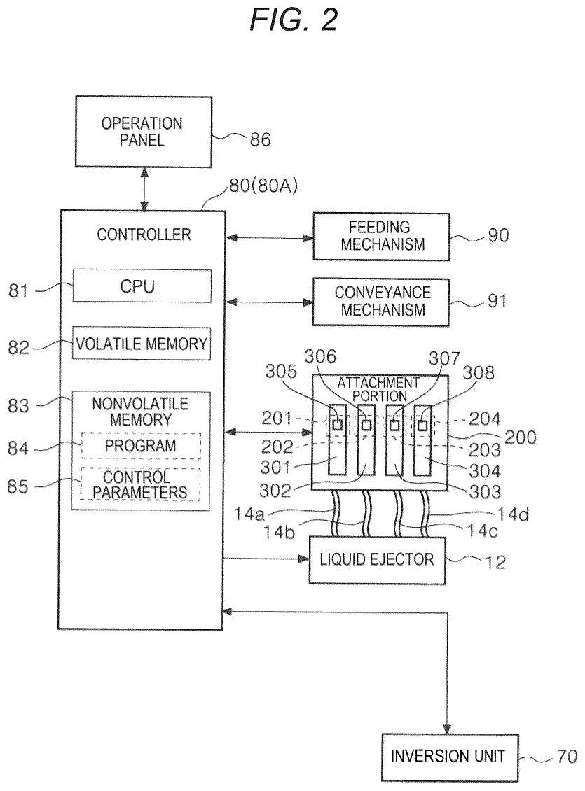

Then, a reference numeral 200 denotes an attachment portion to which a liquid container (described later) containing the liquid to be ejected from the liquid ejector 12 is attached. The liquid ejected from the liquid ejector 12 is supplied from the attachment portion 200 to the liquid ejector 12 via tubes 14a, 14b, 14c, and 14d (see FIG. 2).

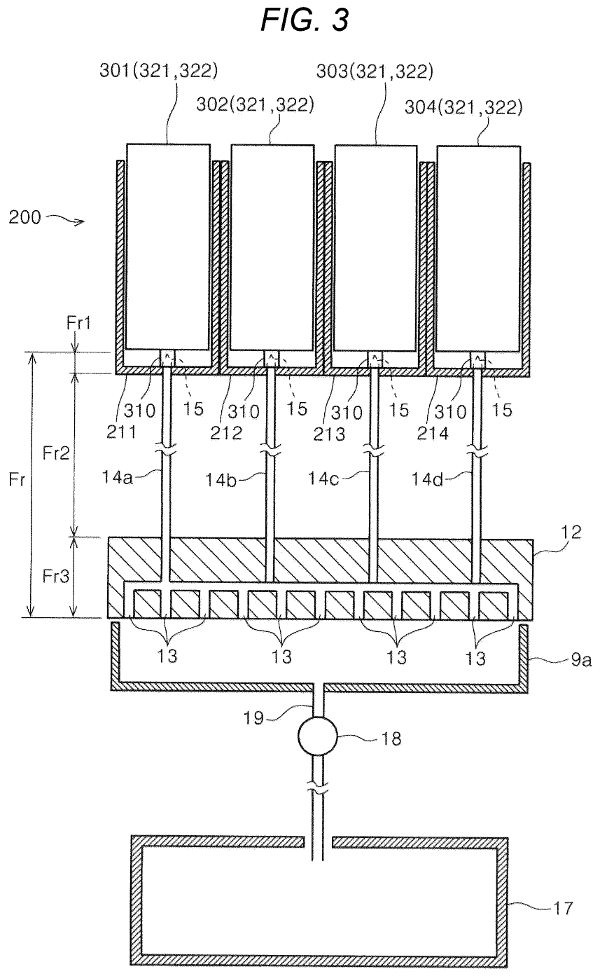

A reference numeral 9 denotes a cap unit including a cap 9a that caps the liquid ejector 12. The cap unit 9 is disposed to be displaced between a separation position (see FIG. 1) where the cap 9a is separated from the liquid ejector 12 and a cap position (see FIG. 3) where the cap 9a caps a head surface 12a of the liquid ejector 12 by a power source (not shown).

Then, the inversion unit 70 will be described. In the present embodiment, the inversion unit 70 is configured as a device separate from the liquid ejection unit 1, can be mechanically and electrically coupled to the liquid ejection unit 1, and can be controlled by a controller 80 of the liquid ejection unit 1 described later. However, the inversion unit 70 is an optional configuration, and may not necessarily be coupled to the liquid ejection unit 1.

Further, in FIG. 1, for the sake of convenience of explanation, the inversion unit 70 is disposed at the +X direction side with respect to the liquid ejection unit 1. However, as will be described later, since the inversion unit 70 is disposed between the two liquid ejection units 1, it can be said that the inversion unit 70 may be located at the −X direction side in some cases when viewed from a specific liquid ejection unit 1.

A side surface at the −X direction side of the inversion unit 70 is provided with the receiving portion K4 that receives the medium. A position of the receiving portion K4 in the apparatus height direction is the same as the position of the discharge portion K3, and the medium discharged from the discharge portion K3 can be received by the receiving portion K4.

The medium conveyance path downstream of the receiving portion K4 branches into a skip path U5 and a switchback carry-in path U1. Therefore, a path switching flap (not shown) is disposed in the vicinity of the downstream of the receiving portion K4.

Further, a side surface at the +X direction side of the inversion unit 70 is provided with a discharge portion K6 that discharges the medium toward the +X direction. In the present embodiment, a position of the discharge portion K6 in the apparatus height direction is the same as the position of the receiving portion K4. Therefore, when the skip path U5 is selected, the medium reaches the discharge portion K6 straight along the X-axis direction from the receiving portion K4 via the skip path U5, and is then discharged from the discharge portion K6 toward the +X direction.

When the switchback carry-in path U1 is selected, the medium enters a switchback path U2 extending along the vertical direction. The switchback path U2 is provided with conveyance roller pairs 55, 56, and 57. Feeding force is applied to the medium fed into the switchback path U2 by the conveyance roller pairs 55, 56 and in some cases additionally by the conveyance roller pair 57 to convey the medium downward. When a rear end of the medium passes through a branch position between the switchback carry-in path U1 and a switchback discharge path U4, the rotational directions of the conveyance roller pairs 55, 56, and 57 are switched, and then the medium is conveyed upward. Then, the medium is discharged toward the +X direction from the discharge portion K6 via the switchback discharge path U4. Therefore, a path switching flap (not shown) or a path guide structure (not shown) is disposed in the vicinity of the upper portion of the conveyance roller pair 55.

Note that a discharge portion K5 is provided below the switchback path U2. The inversion unit 70 can discharge the medium, which is fed into the switchback path U2 from the switchback carry-in path U1, directly from the discharge portion K5 toward the +X direction without switching back the medium.

The configurations of the liquid ejection unit 1 and the inversion unit 70 are as described hereinabove, and the controller 80 will hereinafter be described with reference to FIG. 2.

The controller 80 performs various types of control in the liquid ejection unit 1 and the liquid ejection apparatus described later. Note that in FIG. 2, configurations necessary for the following description are mainly illustrated, and other configurations are not shown. Note that a configuration in which the controller 80 is provided to the liquid ejection unit 1 is not a limitation, and the controller 80 may be disposed outside the liquid ejection unit 1 or outside the liquid ejection apparatus 100 described later.

The controller 80 controls a feeding mechanism 90, a conveyance mechanism 91, the liquid ejector 12, and the attachment portion 200. The controller 80 controls the inversion unit 70 coupled to the liquid ejection unit 1.

The feeding mechanism 90 includes the pickup rollers 21, 22, 23, and 24, the feeding roller pairs 25, 26, 27, and 28, and a motor (not shown) that drives these rollers.

The conveyance mechanism 91 includes the conveyance roller pairs 29 to 54 described above, a motor (not shown) that drives these rollers, the plurality of path switching flaps that switch the destination of the medium described above, and drive sources (not shown) such as solenoids that drive the path switching flaps.

Note that the motor (not shown) constituting the feeding mechanism 90 and the motor (not shown) constituting the conveyance mechanism 91 are, for example, DC motors. Further, each of the motors is provided with a rotary encoder (not shown), and the controller 80 can detect a rotational direction, a rotation amount, and a rotation speed of each of the motors using the rotary encoder. That is, the controller 80 can detect the driving direction, the driving amount, and the driving speed of each of the rollers described above.

The liquid container containing the liquid to be ejected from the liquid ejector 12 can be attached to the attachment portion 200. The types of the liquid include at least the recording liquid for performing recording on the medium and the pretreatment liquid for performing pretreatment on the medium. The ink containing a color material is an example of the recording liquid. Further, the types of the liquid further include a cleaning liquid for cleaning a flow path Fr (see FIG. 3) through which the liquid stored in the liquid container flows before ejected from the liquid ejector 12.

The liquid container containing the ink is hereinafter referred to as an “ink cartridge” in the present embodiment. Further, the liquid container containing the pretreatment liquid is referred to as a “pretreatment liquid cartridge” in the present embodiment. Further, the liquid container containing the cleaning liquid is referred to as a “cleaning liquid cartridge” in the present embodiment. Further, when the cartridges are not distinguished from each other, they may be simply referred to as “cartridges” in some cases. Further, the term “liquid container” may be used instead of the term “cartridge” in some cases.

The ink cartridge is an example of the recording liquid container containing the recording liquid. The pretreatment liquid cartridge is an example of the pretreatment liquid container that contains the pretreatment liquid for performing pretreatment on the medium. Further, the cleaning liquid cartridge is an example of the cleaning liquid container containing the cleaning liquid for cleaning the flow path Fr (see FIG. 3).

Here, the flow path Fr will be described with reference to FIG. 3. FIG. 3 schematically illustrates the flow path of the liquid, and the flow path Fr includes a flow path Fr1 which is a section in the attachment portion 200, a flow path Fr2 which is a section formed of the tubes 14a, 14b, 14c, and 14d coupling the attachment portion 200 and the liquid ejector 12 to each other, and a flow path Fr3 which is a section in the liquid ejector 12 including the nozzles 13. Note that in the following description, when the tubes 14a, 14b, 14c, and 14d are not distinguished from each other, they are collectively referred to as the tube 14.

The flow path Fr can be cleaned by ejecting the cleaning liquid from the nozzles 13 in a state where the cleaning liquid cartridge is attached to the attachment portion 200.

Note that the attachment portion 200 related to the present embodiment includes a first container 211, a second container 212, a third container 213, and a fourth container 214 that house the respective cartridges. That is, a plurality of cartridges can be detachably attached to the attachment portion 200 related to the present embodiment.

A liquid supply needle 15 is disposed on a bottom portion of each of the containers. The liquid supply needle 15 is disposed at one end side of the tube 14. The cartridges are each provided with a liquid supply portion 310, and when the cartridges are attached to the respective cartridge containers, the liquid supply needles 15 enter the respective liquid supply portions 310, and it becomes possible to supply the liquid from the cartridges.

Further, one end of the tube 19 is coupled to the cap 9a that caps the liquid ejector 12. The other end of the tube 19 enters a waste liquid reservoir 17, and thus the liquid ejected to the cap 9a is collected by the waste liquid reservoir 17. Reference numeral 18 denotes a pump which generates negative pressure in the cap 9a. When the pump 18 operates in a state where the cap 9a caps the liquid ejector 12, the liquid is sucked through the nozzles 13.

The cap 9a is an example of a maintenance unit that performs maintenance of the liquid ejector 12.

As described above, in the liquid ejection unit 1, since the flow path Fr can be cleaned, by cleaning the flow path Fr, it is possible to prevent different types of liquids from being mixed with each other, and thus, it is possible to obtain a good result.

Further, in the present embodiment, since it is possible to attach the cleaning liquid cartridge containing the cleaning liquid for cleaning the flow path Fr to the attachment portion 200, the flow path Fr can be easily cleaned. By cleaning the flow path Fr, it is possible to prevent the different types of liquids from being mixed with each other, and thus, it is possible to obtain a good result.

In FIGS. 2 and 3, ink cartridges are attached as an example. Specifically, an ink cartridge 301 containing black ink is attached to the first container 211, an ink cartridge 302 containing magenta ink is attached to the second container 212, an ink cartridge 303 containing cyan ink is attached to the third container 213, and an ink cartridge 304 containing yellow ink is attached to the fourth container 214.

Further, in FIG. 3, a reference numeral 321 denotes a pretreatment liquid cartridge, and a reference numeral 322 denotes a cleaning liquid cartridge.

The pretreatment liquid cartridge 321 or the cleaning liquid cartridge 322 can be attached to each of the containers instead of the ink cartridge.

Note that in the following description, the pretreatment liquid cartridge 321 and the cleaning liquid cartridge 322 may be described by names alone without the reference numerals.

As illustrated in FIG. 2, a cartridge IC as an example of an information holding unit configured to hold information such as a type and a remaining amount of the liquid is provided to the liquid container, that is, the cartridge. A reference numeral 305 denotes the cartridge IC provided to the black ink cartridge 301, and a reference numeral 306 denotes the cartridge IC provided to the magenta ink cartridge 302. Further, a reference numeral 307 denotes the cartridge IC provided to the cyan ink cartridge 303, and a reference numeral 308 denotes the cartridge IC provided to the yellow ink cartridge 304. The cartridge IC of each ink cartridge holds the information such as a fact that the liquid is ink, an ink color, and the remaining amount.

Note that the cartridge ICs are also provided to the pretreatment liquid cartridge and the cleaning liquid cartridge. The cartridge ICs provided to the respective cartridges may hereinafter be simply referred to as the cartridge IC without distinction in some cases.

The attachment portion 200 is provided with contacts that can come into electrical contact with the cartridge ICs. A reference numeral 201 denotes the contact provided to the first container 211, a reference numeral 202 denotes the contact provided to the second container 212, a reference numeral 203 denotes the contact provided to the third container 213, and a reference numeral 204 denotes the contact provided to the fourth container 214.

The controller 80 can detect the information such as the type and the remaining amount of the liquid by reading the information of the cartridge IC. Further, when the liquid is consumed, the controller 80 updates the remaining amount information in the cartridge IC based on the consumption amount. Further, the controller 80 can detect that the cartridge was replaced by reading the information in the cartridge IC at predetermined timing or at predetermined time intervals.

Further, the controller 80 includes a CPU 81 that executes a computer program, in other words, software, a volatile memory 82, and a nonvolatile memory 83. The CPU 81 performs various calculations necessary for executing a program 84 stored in the nonvolatile memory 83. The volatile memory 82 is used as a temporary data storage area. The nonvolatile memory 83 stores the program 84 and control parameters 85 necessary for executing the program 84. The program 84 includes programs for executing various types of processing described later, and the control parameters 85 include parameters for executing the program 84. Various types of processing described later are realized by the controller 80 executing the program 84.

In addition, the controller 80 can receive various operation settings by the user from an operation panel 86 provided to the liquid ejection unit 1. The operation panel 86 includes a touch panel, a power button, and other setting buttons (not shown).

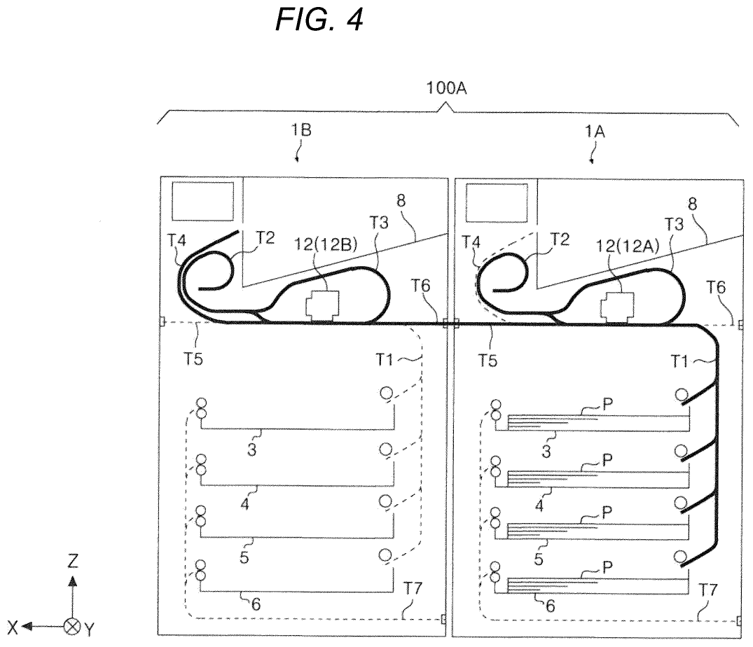

Then, a liquid ejection apparatus using the liquid ejection unit 1 will be described with reference to FIG. 4 and subsequent drawings.

First, the pretreatment liquid and the cleaning liquid will be described below.

At least the ink cartridge and a pretreatment liquid cartridge can be alternatively attached to the attachment portion 200 of the liquid ejection unit 1. Furthermore, the cleaning liquid cartridge may be attachable. Therefore, the ink cartridge, the pretreatment liquid cartridge, and the cleaning liquid cartridge are basically the same in housing shape and size.

For example, when the ink cartridge is attached to the attachment portion 200 of the liquid ejection unit 1, it is possible for that liquid ejection unit 1 to eject the ink to perform recording. Further, for example, when the pretreatment liquid cartridge is attached to the attachment portion 200 of the liquid ejection unit 1, it is possible for that liquid ejection unit 1 to eject the pretreatment liquid onto the medium. Further, for example, when the cleaning liquid cartridge is attached to the attachment portion 200 of the liquid ejection unit 1, it is possible for that liquid ejection unit 1 to clean the flow path Fr.

Note that when a plurality of cartridges can be attached to the attachment portion 200, the ink cartridge and the cleaning liquid cartridge may be mixed, or the pretreatment liquid cartridge and the cleaning liquid cartridge may be mixed. However, it is preferable to exclude a mixture of the ink cartridge and the pretreatment liquid cartridge.

As the pretreatment liquid, those known in the past as liquids for suppressing bleeding of the ink to improve the recording quality by being ejected onto the medium in advance of ejection of the ink can be appropriately adopted, and as an example, a liquid which uses pure water as solvent, and contains an aggregating agent such as multivalent metal salt can be adopted. Obviously, such a pretreatment liquid is illustrative only, and is not a limitation.

Note that the aggregating agent aggregates the color material by reacting with a component such as the color material contained in the ink, and a pigment dispersion and resin that can be contained in the ink. In addition, the aggregating agent increases the viscosity of the ink composition by reacting with the pigment dispersion, the resin, or the pigment dispersion and the resin which may be contained in the ink composition. Therefore, since an ejection failure is caused when the pretreatment liquid and the ink are mixed in the flow path Fr of the liquid, it is necessary to interpose cleaning processing when replacing the ink cartridge with the pretreatment liquid cartridge or when replacing the pretreatment liquid cartridge with the ink cartridge. Obviously, even when the pretreatment liquid does not contain the aggregating agent, for example, when white ink is used as the pretreatment liquid, since a desired processing result cannot be obtained when mixing with the ink of another color, it is necessary to interpose the cleaning processing when replacing the ink cartridge with the pretreatment liquid cartridge or when replacing the pretreatment liquid cartridge with the ink cartridge.

The cleaning liquid may be any liquid as long as it can clean the nozzles 13 and the flow path Fr, and as an example, a liquid which contains pure liquid as a main component and contains a surfactant, a viscosity modifier, and a defoaming agent can be adopted. Obviously, such a cleaning liquid is illustrative only, and is not a limitation.

Then, an example of a specific liquid ejection apparatus will be described. Hereinafter, the liquid ejection apparatus is distinguished from an apparatus in another embodiment by adding a capital letter to the reference numeral 100, but may be collectively referred to as the liquid ejection apparatus 100 when the embodiments are not distinguished from each other.

The liquid ejection apparatus 100A illustrated in FIG. 4 includes a first liquid ejection unit 1A and a second liquid ejection unit 1B. Each of the first liquid ejection unit 1A and the second liquid ejection unit 1B is the liquid ejection unit 1 described with reference to FIG. 1. Note that in FIG. 4 and subsequent drawings, the number of rollers to be displayed and the number of reference numerals to be displayed are reduced from those in FIG. 1 in order to avoid complication of the drawings.

The first liquid ejection unit 1A and the second liquid ejection unit 1B are mechanically coupled to each other with a coupling portion (not shown) and are electrically coupled to each other with a connector (not shown). Accordingly, the controller 80 of the first liquid ejection unit 1A and the controller 80 of the second liquid ejection unit 1B can communicate with each other, and the first liquid ejection unit 1A and the second liquid ejection unit 1B can execute liquid ejection to the medium in cooperation with each other.

Note that in other embodiments hereinafter described, the plurality of liquid ejection units can communicate with each other between the respective controllers 80, and can perform the liquid ejection onto the medium in cooperation with each other in a similar manner.

Various recording settings, recording execution operations, and so on by the user may be made executable by only either one of the first liquid ejection unit 1A and the second liquid ejection unit 1B, or may be made executable by both thereof.

In the liquid ejection apparatus 100A, after the liquid is ejected onto the medium by the first liquid ejection unit 1A, the medium is fed to the second liquid ejection unit 1B, and the liquid is ejected onto the medium by the second liquid ejection unit 1B. The liquid ejector 12 provided to the first liquid ejection unit 1A can be referred to as a first liquid ejector 12A, and the liquid ejector 12 provided to the second liquid ejection unit 1B can be referred to as a second liquid ejector 12B.

As an example, in the present embodiment, the pretreatment liquid cartridge is attached to the attachment portion 200 provided to the first liquid ejection unit 1A, and the ink cartridge is attached to the attachment portion 200 provided to the second liquid ejection unit 1B. That is, the first liquid ejection unit 1A ejects the pretreatment liquid onto the medium, and the second liquid ejection unit 1B ejects the ink onto the medium.

In FIG. 4, a thick solid line represents a medium conveyance path when such liquid ejection is performed. The medium denoted by a reference symbol P is fed from any one of the medium cassettes of the first liquid ejection unit 1A, and is then inverted after the pretreatment liquid is ejected onto the first surface, and then the pretreatment liquid is ejected onto the second surface. Then, the medium is fed to the second liquid ejection unit 1B, and is then inverted after recording is performed on the second surface, and then recording is performed on the first surface, and then the medium is discharged to the discharge tray 8.

However, the discharge destination of the medium is not limited thereto, and the medium may be discharged from the discharge portion K3 through the discharge path T5. In this case, the medium may be discharged to a discharge tray (not shown) attached to the side surface at the +X direction side of the second liquid ejection unit 1B. The discharge tray (not shown) may be configured to be detachably attached to the second liquid ejection apparatus. Further, the medium discharged from the discharge portion K3 may be delivered to a processing apparatus disposed at the +X direction side of the second liquid ejection unit 1B, a relay conveyance device that relays the medium to the processing apparatus, or the like. The processing apparatus may perform, for example, stapling, punching, saddle stitching, folding, or drying.

As described above, the liquid ejection apparatus 100A includes the first liquid ejection unit 1A that ejects the liquid onto the medium, and the second liquid ejection unit 1B that is an apparatus capable of receiving the medium onto which the liquid is ejected by the first liquid ejection unit 1A and ejects the liquid onto the medium. Each of the first liquid ejection unit 1A and the second liquid ejection unit 1B includes the liquid ejector 12 that ejects the liquid onto the medium, the attachment portion 200 to which the liquid container storing the liquid to be ejected from the liquid ejector 12 is attached, and the liquid flow path Fr which reaches the liquid ejector 12 from the attachment portion 200. The ink cartridge containing the ink for performing recording on the medium and the pretreatment liquid cartridge containing the pretreatment liquid for performing the pretreatment on the medium can be alternatively attached to the attachment portion 200. Note that this feature also applies to other liquid ejection apparatuses described below.

According to such a liquid ejection apparatus 100A, it becomes possible to perform the ejection of the ink and the ejection of the pretreatment liquid onto the medium with just one type of liquid ejection unit 1. This makes a dedicated liquid ejection unit to eject the pretreatment liquid unnecessary, and increases the number of modes of use of the two liquid ejection units to thereby improve the usability for the user.

Note that the liquid ejection apparatus 100A includes the two liquid ejection units coupled to each other, but may include three or more liquid ejection units coupled to each other.

Note that when ejecting the pretreatment liquid onto the medium, the controller 80 ejects the pretreatment liquid onto the medium based on recording data when recording is performed on the medium with the ink. Specifically, the pretreatment liquid may be ejected to the same region as the recording region where recording is performed on the medium, or a region that includes the recording region and is slightly larger than the recording region.

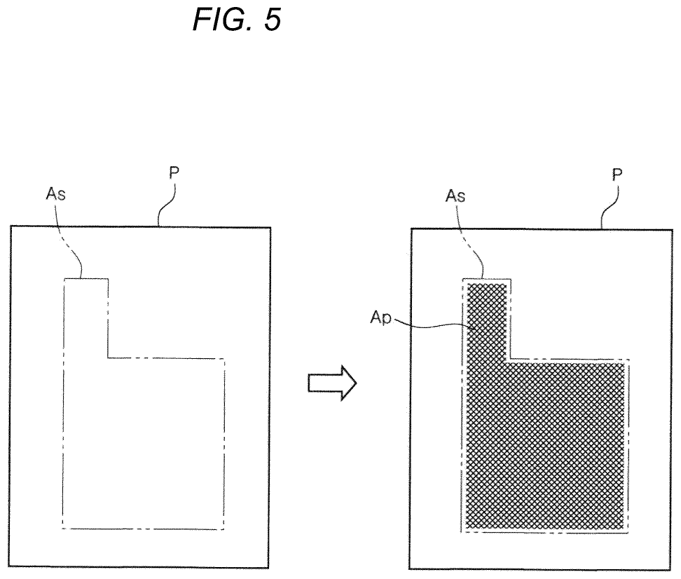

FIG. 5 shows an example of a pretreatment liquid ejection region and the ink ejection region, and in FIG. 5, a reference symbol As denotes the pretreatment liquid ejection region, and in the right diagram of FIG. 5, a reference symbol Ap denotes the ink ejection region. In this example, the pretreatment liquid is ejected to a region slightly larger than the ink ejection region Ap, but the pretreatment liquid ejection region As may be the same as the ink ejection region Ap.

In this way, in particular, when the liquid ejection apparatus is an inkjet printer, since it is possible to freely set the region in which the treatment liquid is ejected, it is possible to suppress the usage amount of the treatment liquid compared to a configuration in which the treatment liquid is uniformly ejected to the entire surface of the medium.

Such a method of ejecting the treatment liquid is also applicable to other liquid ejection systems described below.

The first liquid ejection unit 1A and the second liquid ejection unit 1B according to the present embodiment are the same in apparatus configuration. Accordingly, the usability for the user is improved compared to when the first liquid ejection unit 1A and the second liquid ejection unit 1B have respective apparatus configurations different from each other.

However, the first liquid ejection unit 1A and the second liquid ejection unit 1B may have respective apparatus configurations different from each other.

Further, when defining the flow path Fr provided to the first liquid ejection unit 1A as a first flow path FrA and the flow path Fr provided to the second liquid ejection unit 1B as a second flow path FrB, a first cleaning liquid cartridge containing the cleaning liquid for cleaning the first flow path FrA can be attached to the attachment portion 200 of the first liquid ejection unit 1A. Further, a second cleaning liquid cartridge for cleaning the second flow path FrB can be attached to the attachment portion 200 of the second liquid ejection unit 1B. According to such a configuration, the first flow path FrA and the second flow path FrB can be easily cleaned. Here, the first cleaning liquid cartridge and the second cleaning liquid cartridge may be the same cleaning liquid cartridge.

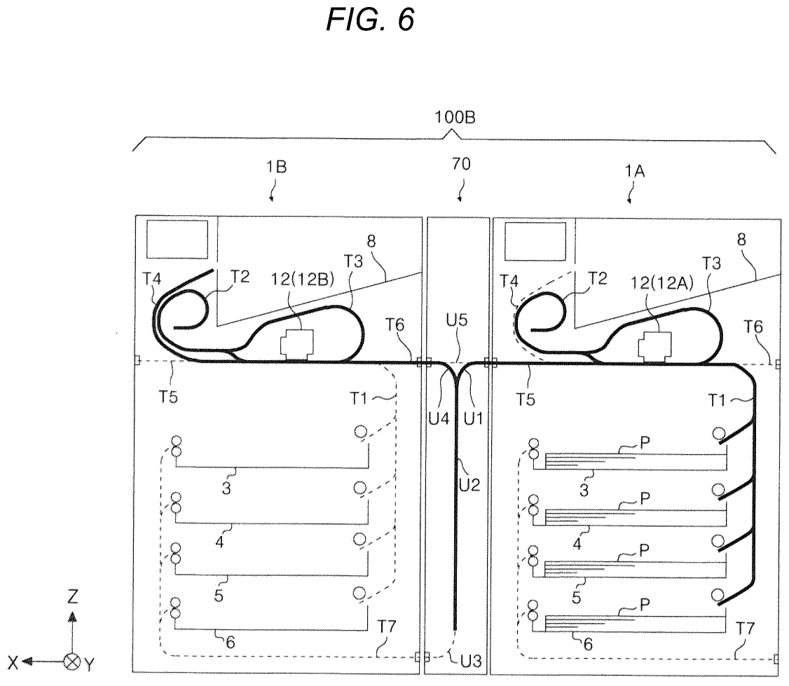

Then, the liquid ejection apparatus 100B illustrated in FIG. 6 includes the inversion unit 70 between the first liquid ejection unit 1A and the second liquid ejection unit 1B.

After the liquid is ejected onto the medium in the first liquid ejection unit 1A, the medium is fed to the inversion unit 70. Then, the medium is inverted using the switchback path U2, then fed to the second liquid ejection unit 1B, and then the liquid is ejected by the second liquid ejection unit 1B.

The first liquid ejection unit 1A ejects, for example, the pretreatment liquid onto the medium, and the second liquid ejection unit 1B ejects, for example, the ink onto the medium.

In FIG. 6, a thick solid line represents a medium conveyance path when such liquid ejection is performed. The medium denoted by a reference symbol P is fed from any one of the medium cassettes of the first liquid ejection unit 1A, and is then inverted after the pretreatment liquid is ejected onto the first surface, and then the pretreatment liquid is ejected onto the second surface. Then, the medium is inverted by the inversion unit 70, then fed to the second liquid ejection unit 1B, and is then inverted after recording is performed on the first surface, and then recording is performed on the second surface, and then the medium is discharged to the discharge tray 8.

According to such a usage aspect of the liquid ejection apparatus 100B, unlike the liquid ejection apparatus 100A described above, since the pretreatment on the first surface of the medium, the pretreatment on the second surface, the recording on the first surface, and the recording on the second surface are performed in this order, it is possible to prevent a large difference in time from when performing the pretreatment to when performing the recording from occurring between the first surface and the second surface. That is, when defining time Tm1 as time from when the pretreatment liquid is ejected onto the first surface of the medium to when the ink is ejected, and time Tm2 as time from when the pretreatment liquid is ejected onto the second surface of the medium to when the ink is ejected, a difference between the time Tm1 and the time Tm2 can be suppressed.

On this occasion, it is preferable to make the time it takes to invert the medium in the switchback path T2 and the inversion path T3 the same for the first liquid ejection unit 1A and the second liquid ejection unit 1B. That is, such a liquid ejection apparatus 100B as described above can suppress the difference between the time Tm1 and the time Tm2 while preventing the growth in size of the system in the X-axis direction, and by extension, it is possible to suppress a difference in recording quality between the first surface and the second surface of the medium.

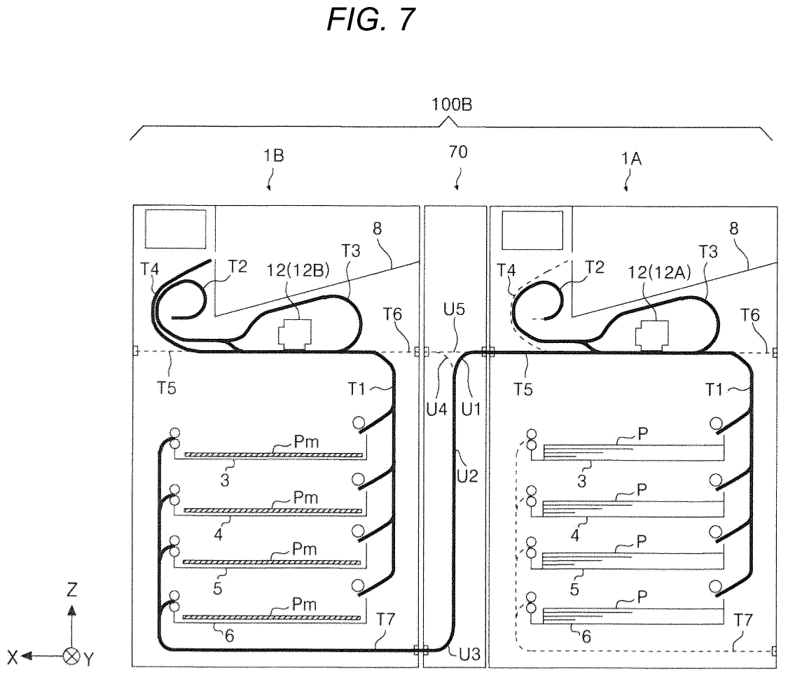

Then, FIG. 7 illustrates another usage form of the liquid ejection apparatus 100B.

In the present embodiment, the second liquid ejection unit 1B receives the medium onto which the liquid is ejected by the first liquid ejection unit 1A, and conveys the medium thus received into each of the medium cassettes using the carry-in path T7. Then, the medium carried into each of the medium cassettes is fed and the liquid is ejected. In FIG. 7, a reference symbol Pm denotes the medium carried into each of the medium cassettes.

According to such a usage aspect, it is possible to ensure the drying time by storing the medium onto which the liquid is ejected by the first liquid ejection unit 1A in each of the medium cassettes of the second liquid ejection unit 1B. In addition, by using the medium cassettes which are elements for feeding the medium, there is no need to prepare a dedicated medium storage place, and it is possible to achieve a reduction in size of the apparatus.

Note that the order in which the medium is carried into the medium cassettes and the order in which the medium is taken out when feeding the medium can be appropriately set, but it is desirable to adopt an aspect in which the drying time of the medium can be ensured. For example, when a plurality of medium cassettes is used, instead of immediately feeding the medium that has just been carried in a predetermined medium cassette, it is preferable to feed the medium first that has previously been carried in another medium cassette.

In addition, it is not necessary to use all the plurality of medium cassettes, and any one or more of the medium cassettes may be used.

As an example, when the medium is carried in, the medium is carried in the order of the first medium cassette 3, the second medium cassette 4, the third medium cassette 5, and the fourth medium cassette 6. Subsequently, by feeding the medium in substantially the same order, the drying time of the medium can be ensured, and the drying time can be made uniform in the medium cassettes. Note that instead of sequentially carrying in and then feeding the media from the upper medium cassette to the lower medium cassette in this way, the media may be sequentially carried in and then fed from the lower medium cassette to the upper medium cassette.

In addition, the medium may be carried into one medium cassette in advance to a storage limit, and the medium may be stored in another medium cassette to the storage limit while the medium is fed from the medium cassette until the medium runs out.

Further, a configuration in which the medium is carried in from above the medium cassette and is taken out from the bottom portion of the medium carried therein may be adopted.

In addition, carrying the medium into each of the medium cassettes and ejecting the liquid by the second liquid ejection unit 1B without carrying the medium into each of the medium cassettes using the skip path U5 of the inversion unit 70 may be used together.

Further, when throughput in the first liquid ejection unit 1A is higher than throughput in the second liquid ejection unit 1B, one of the medium cassettes may be used as a buffer, and carrying in and feeding may be performed in sequence using other medium cassettes. Then, when the processing overflows, the medium received therein may be evacuated to the medium cassette serving as the buffer.

As described above, the second liquid ejection unit 1B includes the plurality of medium cassettes. When defining one of the plurality of medium cassettes as a first medium container and another thereof as a second medium container, the second liquid ejection unit 1B can execute a step of carrying the first medium received therein into the first medium container, a step of carrying the second medium received subsequently to the first medium into the second medium container, and a step of feeding the second medium to the liquid ejector 12 after feeding the first medium to the liquid ejector 12.

Accordingly, since the medium carried in first is fed first using the two medium cassettes, it is possible to ensure the drying time.

Further, in the present embodiment, the second liquid ejection unit 1B feeds the first medium carried into the first medium container to the liquid ejector 12, and then carries the medium received therein into the first medium container. As a result, it is possible to prevent the order of use of the medium previously carried into the first medium container and the medium subsequently carried into the first medium container from being reversed.

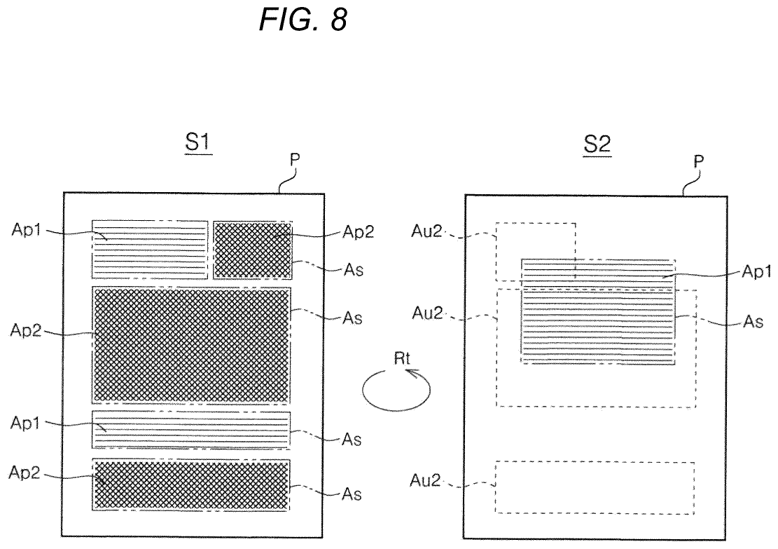

Then, the adjustment of the ejection of the pretreatment liquid will be described with reference to FIG. 8 and subsequent drawings.

When the pretreatment liquid is ejected before the ink is ejected onto the medium, the amount of the liquid absorbed by the medium becomes larger compared to when only the ink is ejected. As a result, the difference in liquid absorption between the first surface and the second surface of the medium increases, and the curl may become conspicuous in some cases.

A difference in liquid absorption between the first surface S1 and the second surface S2 of the medium P will be described with reference to FIG. 8.

In FIG. 8, reference symbols Ap1, Ap2 denote the ink ejection regions. As an example, the ink ejection region Ap1 is a text printing region, the ink ejection region Ap2 is an image printing region such as a photograph, and the ink ejection region Ap2 is higher in ink ejection duty than the ink ejection region Ap1. Here, the ink ejection duty is an ink ejection amount per unit area.

Further, in FIG. 8, a reference symbol As denotes a pretreatment liquid ejection region. The pretreatment liquid ejection region As may coincide with the ink ejection regions Ap1 and Ap2, or may have a margin with respect to the ink ejection regions AP1, Ap2 as described with reference to FIG. 5.

The first surface S1 has a plurality of ink ejection regions Ap2, whereas the second surface S2 has no ink ejection region Ap2 and has only one ink ejection region Ap1. Accordingly, the liquid absorption amount of the first surface S1 is larger than the liquid absorption amount of the second surface S2, that is, the difference in liquid absorption between the first surface S1 and the second surface S2 increases, and the tendency of curling increases.

Note that the second surface S2 illustrated in FIG. 8 is obtained by horizontally inverting the first surface S1 while keeping the vertical direction as indicated by an arrow Rt. Further, on the second surface S2, a reference symbol Au2 denotes a region corresponding to the ink ejection region Ap2 in the first surface S1. In other words, the region Au2 is a region obtained by transmitting the ink ejection region Ap2 on the first surface S1 to the second surface S2.

Based on the recording data, the pretreatment liquid is ejected to the pretreatment liquid ejection region As corresponding to the ink ejection region Ap1 on the second surface S2. However, in the second surface S2, the region Au2 is a region where a difference in liquid absorption from the first surface S1 becomes conspicuous, and causes a curl. Therefore, when the pretreatment liquid is ejected to the region Au2 on the second surface S2, the difference in liquid absorption between the first surface S1 and the second surface S2 is reduced, and the curl can be suppressed. Additionally ejecting the pretreatment liquid to suppress the difference in liquid absorption between the first surface S1 and the second surface S2 in this way is referred to as an adjustment of the ejection of the pretreatment liquid.

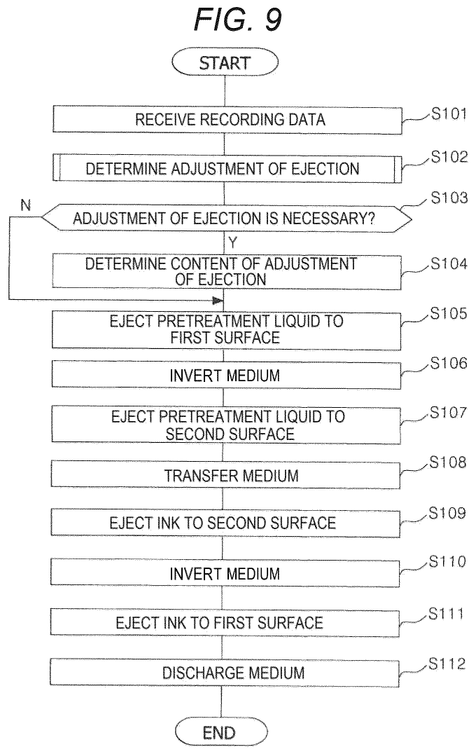

Processing performed by the controller 80 will hereinafter be described with reference to FIG. 9. Note that it is assumed that the processing of FIG. 9 uses the liquid ejection apparatus 100A described with reference to FIG. 4 as an example.

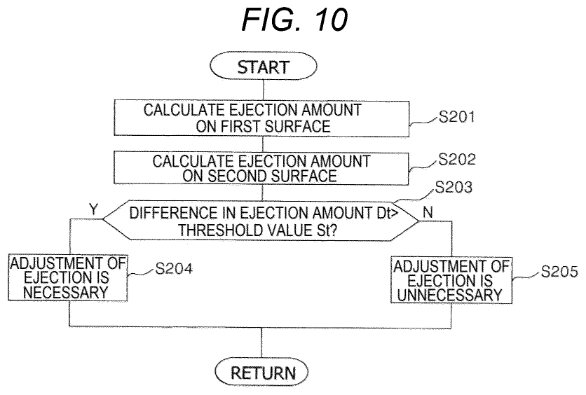

When the controller 80 receives the recording data (step S101), the controller 80 determines the adjustment of the ejection of the pretreatment liquid (step S102). This determination of the adjustment of the ejection will be described later with reference to FIG. 10.

As a result of the determination of the adjustment of the ejection, when it is determined that the adjustment of the ejection of the pretreatment liquid is necessary (Yes in step S103), the controller 80 determines the content of the adjustment of the ejection (step S104). This content of the adjustment of the ejection will also be described later separately.

As a result of the determination of the adjustment of the ejection, when it is determined that the adjustment of the ejection is unnecessary (No in step S103), the process proceeds to step S105.

The controller 80 ejects the pretreatment liquid onto the first surface S1 with the first liquid ejection unit 1A (step S105) based on the recording data (No in step S103) or based on the content of the adjustment of the ejection (Yes in step S103). Then, the controller 80 inverts the medium in the first liquid ejection unit 1A (step S106). The controller 80 ejects the pretreatment liquid onto the second surface S2 with the first liquid ejection unit 1A (step S107) based on the recording data (No in step S103) or based on the content of the adjustment of the ejection (Yes in step S103).

Then, the controller 80 delivers the medium from the first liquid ejection unit 1A to the second liquid ejection unit 1B (step S108).

Then, the controller 80 ejects the ink to the second surface S2 based on the recording data with the second liquid ejection unit 1B (step S109). Subsequently, the controller 80 inverts the medium in the second liquid ejection unit 1B (step S110). Then, the controller 80 ejects the ink onto the second surface S2 based on the recording data with the second liquid ejection unit 1B (step S111), and then discharges the medium (step S112).

Then, the determination of the adjustment of the ejection will be described with reference to FIG. 10.

First, based on the recording data, the controller 80 calculates the ejection amount of the first surface S1 (step S201), and further calculates the ejection amount of the second surface S2 (step S202).

Then, the controller 80 determines whether an ejection amount difference Dt, which is a difference in the ejection amount between the first surface S1 and the second surface S2, exceeds a predetermined threshold value St (step S203). The threshold value St is stored in the nonvolatile memory 83. As a result, when the ejection amount difference Dt exceeds the predetermined threshold value St (Yes in step S203), the controller 80 determines that the adjustment of the ejection of the pretreatment liquid is necessary (step S204). Further, when the ejection amount difference Dt is equal to or less than the predetermined threshold value St (No in step S203), the controller 80 determines that the adjustment of the ejection of the pretreatment liquid is unnecessary (step S205).

Note that the ejection amount difference Dt, which is the difference in liquid absorption between the first surface S1 and the second surface S2, can be a difference between the ink ejection amount to the first surface S1 and the ink ejection amount to the second surface S2. Accordingly, the difference in liquid absorption can be easily determined.

However, the ejection amount difference Dt may be a difference between the ejection amount of the pretreatment liquid onto the first surface S1 and the ejection amount of the pretreatment liquid onto the second surface S2.

Further, the ejection amount difference Dt may be a difference between the sum of the pretreatment liquid ejection amount and the ink ejection amount to the first surface S1 and the sum of the pretreatment liquid ejection amount and the ink ejection amount to the second surface S2. Accordingly, the difference in liquid absorption can be more accurately figured out, and by extension, the difference in liquid absorption can be more appropriately suppressed.

Then, the determination of the content of the adjustment of the ejection (step S104 in FIG. 9) will be described.

The determination of the content of the adjustment of the ejection is a determination of how much the pretreatment liquid is ejected to which region of which surface. In the example of FIG. 8, since the second surface S2 is smaller in liquid absorption amount than the first surface S1, the pretreatment liquid is ejected to the second surface S2 to suppress the difference in liquid absorption. Accordingly, on the second surface S2, ejection of the pretreatment liquid is different from the ejection thereof based on the print data.

On this occasion, the pretreatment liquid can be ejected to the region Au2 corresponding to the ink ejection region Ap2 of the first surface S1. Accordingly, on the second surface S2, the pretreatment liquid is ejected to the region Au2 in addition to the pretreatment liquid ejection region As based on the recording data.

Note that when the pretreatment liquid ejection region As based on the recording data and the region Au2 corresponding to the ink ejection region Ap2 on the first surface S1 overlap each other, a region excluding the pretreatment liquid ejection region As in the region Au2 corresponds to a region to which the pretreatment liquid is additionally ejected for the adjustment of the ejection.

Note that in the embodiment described above, the pretreatment liquid is not additionally ejected to the region corresponding to the ink ejection region Ap1 on the first surface S1, but the pretreatment liquid may also be additionally ejected to the region corresponding to the ink ejection region Ap1 on the first surface S1. Further, a threshold value for determining whether to perform the additional ejection of the pretreatment liquid may be provided, and the pretreatment liquid may be additionally ejected to the corresponding region of the opposite surface when the ink ejection duty in the ink ejection region exceeds the threshold value.

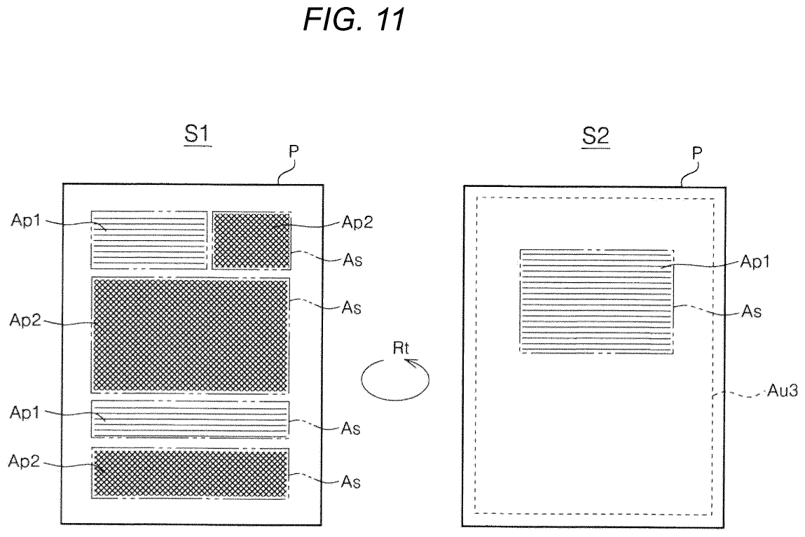

Further, when the pretreatment liquid is additionally ejected, the pretreatment liquid may be ejected to the entire area of the second surface S2. A region Au3 on the second surface S2 shown in FIG. 11 is an example thereof. In this way, the whole of the second surface S2 gets wet, which also makes a contribution to suppression of scattering of paper dust.

Note that although the determination of the adjustment of the ejection of the pretreatment liquid illustrated in FIG. 10 and the determination of the content of the adjustment of the ejection in step S104 of FIG. 9 are performed based on the entire surface of the medium, the medium may be divided into several regions to determine the adjustment of the ejection of the pretreatment liquid and the content of the adjustment of the ejection for each region.

Further, in addition to the determination in step S203 in FIG. 10, the necessity of the adjustment of the ejection of the pretreatment liquid may be determined, and the content of the adjustment of the ejection may be determined, based on the information of the medium. For example, when the medium is difficult to curl such as when the medium is thick or high in rigidity, the adjustment of the ejection of the pretreatment liquid may be unnecessary in some cases.

In addition, even when the adjustment of the ejection is to be performed, when the curl is difficult to occur, just a minor adjustment of the ejection may be sufficient in some cases. Specifically, when there are a first medium P1 and a second medium P2 higher in rigidity than the first medium P1, it is possible to reduce the ejection duty and the ejection region in the second medium P2 when the pretreatment liquid is additionally ejected compared to the first medium P1. Accordingly, it is possible to appropriately suppress the curl of the medium while suppressing the ejection amount of the pretreatment liquid.

Further, the threshold value St used for the determination in step S203 in FIG. 10 may be changed based on the information of the medium. For example, when the medium is hard to curl, such as when the medium is thick or high in rigidity, the threshold value St may be made higher than when the medium is easy to curl, such as when the medium is thin or low in rigidity.

As described above, the controller 80 performs the adjustment of the ejection of the pretreatment liquid to suppress the difference in liquid absorption between the first surface S1 and the second surface S2 based on the recording data. Further, the method of controlling the liquid ejection apparatus 100 realized by the controller 80 includes a step of performing adjustment of the ejection of the pretreatment liquid to suppress the difference in liquid absorption between the first surface S1 and the second surface S2 based on the recording data.

Accordingly, it is possible to suppress the curl caused by the difference in liquid absorption between the first surface S1 and the second surface S2.

As in the present embodiment, in the configuration in which the ink is ejected by the second liquid ejection unit 1B onto the medium onto which the pretreatment liquid has been ejected by the first liquid ejection unit 1A, there is a concern that the medium may come into contact with the liquid ejector 12B of the second liquid ejection unit 1B due to the curl of the medium on which the pretreatment has been performed with the pretreatment liquid. On this occasion, when the pretreatment liquid ejected onto the medium adheres to the liquid ejector 12B of the second liquid ejection unit 1B, there is a possibility that a problem such as clogging of the nozzle of the liquid ejector 12B occurs. Therefore, it is preferable to suppress the curl as in the present embodiment.

Note that the “difference in liquid absorption” is defined as a difference between the liquid absorption amount of the first surface S1 and the liquid absorption amount of the second surface S2 in the embodiment described above, but may be a difference between the liquid absorption range of the first surface S1 and the liquid absorption range of the second surface S2, and specifically, a difference between the liquid absorption area of the first surface S1 and the liquid absorption area of the second surface S2.

Further, the controller 80 may perform the adjustment of the ejection of the pretreatment liquid such that the sum of the ejection amounts of the pretreatment liquid and the ink to the first surface S1 becomes equal to the sum of the ejection amounts of the pretreatment liquid and the ink to the second surface S2. Accordingly, the difference in liquid absorption between the first surface S1 and the second surface S2 can appropriately be suppressed, and thus the curl caused by the difference in liquid absorption can be more appropriately suppressed.

Further, in the embodiment described above, the controller 80 ejects the pretreatment liquid to the region Au2 which is the region of the second surface S2 and corresponds to the ink ejection region Ap2 with respect to the first surface S1. Further, the method of controlling the liquid ejection apparatus 100 realized by the controller 80 includes a step of ejecting the pretreatment liquid to the region Au2 which is the region of the second surface S2, and corresponds to the ink ejection region Ap2 with respect to the first surface S1.

Accordingly, the difference in liquid absorption between the first surface S1 and the second surface S2 can appropriately be suppressed, and thus the curl caused by the difference in liquid absorption can be more appropriately suppressed.

Note that when the additional ejection of the pretreatment liquid for the adjustment of the ejection is performed on the first surface S1, the pretreatment liquid is ejected to a region of the first surface S1 corresponding to the ink ejection region with respect to the second surface S2.

The controller 80 may execute the ejection of the pretreatment liquid for suppressing the difference in liquid absorption between the first surface S1 and the second surface S2 as a normal pretreatment without determining the adjustment of the ejection illustrated in FIG. 10. That is, the controller 80 may eject the pretreatment liquid to the region Au2 which is the region of the second surface S2 and corresponds to the ink ejection region Ap2 with respect to the first surface S1, and eject the pretreatment liquid to the region which is the region of the first surface S1 and corresponds to the ink ejection region with respect to the second surface S2 without performing the determination of the adjustment of the ejection illustrated in FIG. 10. Accordingly, the difference in liquid absorption between the first surface S1 and the second surface S2 can be appropriately suppressed without considering the ejection amount and so on, and by extension, the curl caused by the difference in liquid absorption can be more appropriately suppressed.

Further, when increasing the ejection amount of the pretreatment liquid in the adjustment of the ejection of the pretreatment liquid, the controller 80 may eject the pretreatment liquid to a second region outside a first region that is the ejection region of the pretreatment liquid corresponding to the ink ejection region. In FIG. 11, the pretreatment liquid ejection region As on the second surface S2 is an example of the first region, and a region excluding the pretreatment liquid ejection region As out of the region Au3 is an example of the second region.

By such an ejection of the pretreatment liquid, the difference in liquid absorption between the first surface S1 and the second surface S2 can be suppressed, and by ejecting the pretreatment liquid to the second region, scattering of the paper dust can be suppressed.

Further, the ejection amount of the pretreatment liquid per unit area in the second region may be made smaller than the ejection amount of the pretreatment liquid per unit area in the first region. In this way, it is possible to suppress the difference in liquid absorption while saving the pretreatment liquid, and by extension, it is possible to suppress the curl caused by the difference in liquid absorption.

Note that since it is possible to achieve the suppression of the scattering of the paper dust by ejecting the pretreatment liquid to wet the surface of the medium as described above, it is also possible to eject the pretreatment liquid for the purpose of suppressing the scattering of the paper dust as control independent of the adjustment of the ejection of the pretreatment liquid or as control in addition to the adjustment of the ejection of the pretreatment liquid.

For example, when the ejection amount or the ejection area of the pretreatment liquid based on the recording data is smaller than a predetermined threshold value, the pretreatment liquid may be additionally ejected for the purpose of suppressing scattering of the paper dust. On this occasion, by ejecting the pretreatment liquid onto the entire surface of the medium regardless of the ink ejection region based on the recording data, scattering of the paper dust can be effectively suppressed.

In addition, when performing the processing described above, it is also preferable to set the ejection content of the pretreatment liquid based on the type of the medium, specifically, the ease of generation of the paper dust. Since the ease of generation of the paper dust varies depending on, for example, the type of fiber of the medium, surface treatment, and so on, when the paper dust is apt to be generated according to the type of the medium, it is preferable to increase the ejection duty of the pretreatment liquid compared to when the paper dust is relatively difficult to be generated. Further, in the case of the medium which is difficult to generate the paper dust, the ejection of the pretreatment liquid for the purpose of suppressing scattering of the paper dust can be omitted.

Further, the ease of the paper dust generation varies in nature depending on the conveyance speed of the medium. Therefore, when comparing the conveyance speed of the medium between first speed and second speed higher than the first speed, it is preferable to perform the ejection of the pretreatment liquid for the purpose of suppressing the scattering of the paper dust in the case of the second speed.

Further, when the pretreatment liquid is ejected onto the entire surface of the medium, the curl can be appropriately suppressed by adjusting the margin amount in accordance with the grain direction of the fiber in some cases.

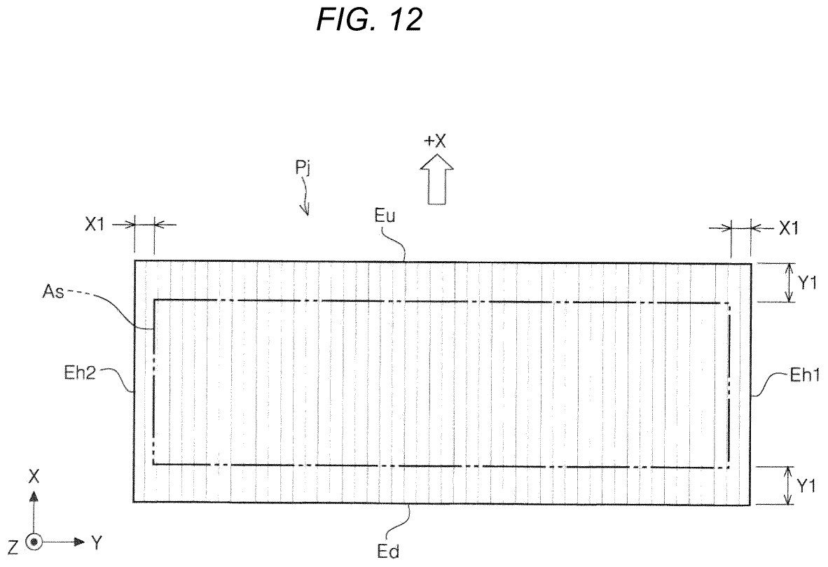

FIG. 12 illustrates when the grain direction of the medium Pj is along the conveyance direction when the medium Pj passes below the liquid ejector 12 toward the +X direction. Note that a reference symbol Eu denotes a leading edge, and a reference symbol Ed denotes a trailing edge. Further, reference symbols Eh1, Eh2 denote side end edges. When the grain direction of the medium Pj is along the conveyance direction in this manner, when liquid is ejected onto the surface at the +Z direction side of the medium Pj, the medium Pj curls along the Y-axis direction due to liquid absorption so that the side end edges Eh1, Eh2 rise toward the liquid ejector 12.

In this case, it is preferable to make the margin amount Y1 of the leading end and the trailing end of the medium Pj larger than the margin amount Xl of the side ends. Accordingly, in a comparison when the area of the pretreatment liquid ejection region As is the same, relatively large margin portions in the leading end and the trailing end that do not absorb the liquid serve as a resistance against the curl along the Y-axis direction, and the curl along the Y-axis direction can be suppressed.

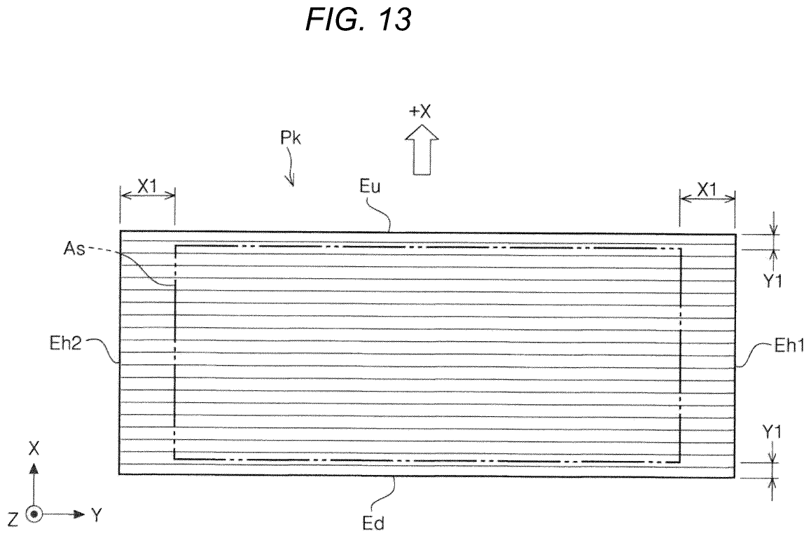

FIG. 13 illustrates when the grain direction of the medium Pk is along the Y-axis direction, that is, the width direction crossing the conveyance direction when the medium Pk passes toward the +X direction below the liquid ejector 12. When the grain direction of the medium Pk is along the width direction in this manner, when the liquid is ejected onto the surface at the +Z direction side of the medium Pk, the medium Pk curls along the X-axis direction so that the leading edge Eu and the trailing edge Ed rise toward the liquid ejector 12 due to liquid absorption.

In this case, it is preferable to make the margin amount Xl of the side end of the medium Pk larger than the margin amount Y1 of the leading end and the trailing end. Accordingly, in a comparison when the area of the pretreatment liquid ejection region As is the same, relatively large margin portions in the side ends that do not absorb the liquid serve as a resistance against the curl along the X-axis direction, and the curl along the X-axis direction can be suppressed.

Note that the settings of the pretreatment liquid ejection region As described with reference to FIGS. 12 and 13, specifically, the relationship between the fiber grain direction and the vertical and horizontal margin amounts can also be used for the determination of the adjustment of the ejection of the pretreatment liquid described with reference to FIG. 10 and the determination of the content of the adjustment of the ejection of the pretreatment liquid in step S104 of FIG. 9.

For example, when it can be determined that the curl is difficult to occur based on the relationship between the fiber grain direction and the amounts of the vertical and horizontal margins, the adjustment of the ejection of the pretreatment liquid can be omitted, or the ejection amount and the ejection range can be suppressed when the additional ejection of the pretreatment liquid is performed. In addition, it is possible to further suppress the curl by performing margin setting as illustrated in FIGS. 12 and 13 when the content of the adjustment of the ejection of the pretreatment liquid is determined.

The present disclosure is not limited to the embodiment and the modifications described above. Various modifications are possible within the scope of the disclosure set forth in the appended claims. It is obvious that the modifications are also included within the scope of the present disclosure.

What is claimed is:

1. A liquid ejection apparatus comprising:
a first liquid ejector configured to eject a pretreatment liquid as a liquid for pretreatment onto a medium;
a second liquid ejector configured to eject a recording liquid as a liquid for recording onto the medium onto which the liquid is ejected by the first liquid ejector; and
a controller configured to control the first liquid ejector and the second liquid ejector, wherein
one surface of the medium is defined as a first surface and another surface of the medium is defined as a second surface,
the controller is configured to perform an adjustment of the ejection of the pretreatment liquid to suppress a difference in liquid absorption between the first surface and the second surface based on recording data.

2. The liquid ejection apparatus according to claim 1, wherein
the controller is configured to perform an adjustment of the ejection of the pretreatment liquid based on information of the medium.

3. The liquid ejection apparatus according to claim 1, wherein
the difference in liquid absorption is a difference between an ejection amount of the recording liquid onto the first surface and an ejection amount of the recording liquid onto the second surface.

4. The liquid ejection apparatus according to claim 1, wherein
the difference in liquid absorption is a difference between a sum of ejection amounts of the pretreatment liquid and the recording liquid onto the first surface and a sum of ejection amounts of the pretreatment liquid and the recording liquid onto the second surface.

5. The liquid ejection apparatus according to claim 4, wherein
the controller is configured to perform an adjustment of the ejection of the pretreatment liquid such that the sum of the ejection amounts of the pretreatment liquid and the recording liquid onto the first surface is equal to the sum of the ejection amounts of the pretreatment liquid and the recording liquid onto the second surface.

6. The liquid ejection apparatus according to claim 4, wherein
the controller is configured to
eject the pretreatment liquid to a region of the first surface corresponding to an ejection region of the recording liquid onto the second surface, or
eject the pretreatment liquid to a region of the second surface corresponding to an ejection region of the recording liquid onto the first surface.

7. The liquid ejection apparatus according to claim 1, wherein
the controller is configured to eject the pretreatment liquid to a second region outside a first region which is an ejection region of the pretreatment liquid corresponding to an ejection region of the recording liquid when increasing an ejection amount of the pretreatment liquid in the adjustment of the ejection of the pretreatment liquid.

8. The liquid ejection apparatus according to claim 7, wherein
an ejection amount of the pretreatment liquid per unit area in the second region is smaller than an ejection amount of the pretreatment liquid per unit area in the first region.

9. A liquid ejection apparatus comprising:
a first liquid ejector configured to eject a pretreatment liquid as a liquid for pretreatment onto a medium;
a second liquid ejector configured to eject a recording liquid as a liquid for recording onto the medium onto which the liquid is ejected by the first liquid ejector; and
a controller configured to control the first liquid ejector and the second liquid ejector, wherein
one surface of the medium is defined as a first surface and another surface of the medium as a second surface,
the controller is configured to
eject the pretreatment liquid in a region of the first surface corresponding to an ejection region of the recording liquid onto the second surface, and
eject the pretreatment liquid in a region of the second surface corresponding to an ejection region of the recording liquid onto the first surface.

10. The liquid ejection apparatus according to claim 1, wherein
a first liquid ejection unit including the first liquid ejector and a second liquid ejection unit including the second liquid ejector are coupled to each other.

11. The liquid ejection apparatus according to claim 10, wherein
each of the first liquid ejection unit and the second liquid ejection unit includes an attachment portion to which a liquid container storing the liquid is attached, and
a recording liquid container as the liquid container storing the recording liquid and a pretreatment liquid container as the liquid container storing the pretreatment liquid are configured to be alternatively attached to the attachment portion.

12. The liquid ejection apparatus according to claim 11, wherein
the first liquid ejection unit includes a first flow path that is a flow path of a liquid from the attachment portion to the first liquid ejector,
the second liquid ejection unit includes a second flow path that is a flow path of a liquid from the attachment portion to the second liquid ejector,
a first cleaning liquid container storing a cleaning liquid configured to clean the first flow path is configured to be attached to the attachment portion of the first liquid ejection unit, and
a second cleaning liquid container storing a cleaning liquid configured to clean the second flow path is configured to be attached to the attachment portion of the second liquid ejection unit.

13. The liquid ejection apparatus according to claim 12, wherein
the first liquid ejection unit and the second liquid ejection unit are same in configuration.

14. The liquid ejection apparatus according to claim 10, further comprising:
a inversion unit configured to invert the medium received from the first liquid ejection unit to convey the medium to the second liquid ejection unit.

15. A method of controlling a liquid ejection apparatus including
a first liquid ejector configured to eject a pretreatment liquid as a liquid for pretreatment onto a medium, and
a second liquid ejector configured to eject a recording liquid as a liquid for recording onto the medium onto which the liquid is ejected by the first liquid ejector, wherein one surface of the medium is defined as a first surface and another surface of the medium is defined as a second surface, the method comprising:
performing an adjustment of the ejection of the pretreatment liquid to suppress a difference in liquid absorption between the first surface and the second surface based on recording data.
